(19) United States
(12) Patent Application Publication
(10) Pub. No.: US 2017/0318574 A1
(43) Pub. Date: Nov. 2, 2017

(54) METHOD AND APPARATUS FOR TRANSMITTING UPLINK CONTROL CHANNEL FOR HIGH SPEED TERMINAL

(71) Applicant: ELECTRONICS AND TELECOMMUNICATIONS RESEARCH INSTITUTE, Daejeon (KR)

(72) Inventors: Sung woo CHOI, Daejeon (KR); IL GYU KIM, Chungcheongbuk-do (KR)

(73) Assignee: ELECTRONICS AND TELECOMMUNICATIONS RESEARCH INSTIT UTE, Daejeon (KR)

(21) Appl. No.: 15/498,445

(22) Filed: Apr. 26, 2017

(30) Foreign Application Priority Data
Apr. 27, 2016 (KR) 10-2016-0051731

(51) Int. Cl. H04W 72/04; H04L 5/00; H04L 25/03

(52) U.S. Cl. CPC H04W 72/0413; H04W 72/048; H04L 5/0048; H04W 72/0453; H04L 2025/03796

(57) ABSTRACT

Disclosed herein are a method and an apparatus for transmitting an uplink control channel for a high speed terminal. In a method for transmitting an uplink control channel in a mobile communication system, an uplink control channel signal is generated depending on at least one resource index received from a base station and the uplink control channel signal is transmitted to the base station through a resource block corresponding to the resource index. A location where the uplink control channel signal is allocated is changed depending on the resource index.

### CROSS-REFERENCE TO RELATED APPLICATION

This application claims priority to and the benefit of Korean Patent Application No. 10-2016-0051731 filed in the Korean Intellectual Property Office on Apr. 27, 2016, the entire contents of which are incorporated herein by reference.

### BACKGROUND OF THE INVENTION

### (a) Field of the Invention

The present invention relates to a method and an apparatus for transmitting an uplink control channel for a high speed terminal.

### (b) Description of the Related Art

A long term evolution (LTE) system uses an orthogonal frequency division multiplexing (OFDM) transmission scheme, configures a specific frequency for an uplink transmission, and allows a plurality of terminals to use the configured specific frequency to perform the uplink transmission. At the time of the uplink transmission, the LTE system transmits signals orthogonal to each other.

An uplink control channel is a physical layer channel transmitting control information associated with a downlink transmission, control information associated with the uplink transmission, or the like. As the signal transmitted through the uplink control channel, there are a channel quality information (CQI), hybrid automatic repeat request (HARQ)-acknowledgement (ACK) that is an uplink response signal depending a downlink data transmission, a scheduling request signal requesting scheduling, or the like.

An OFDM-based communication system like the LTE uses a periodically transmitted reference signal to compensate for a channel and perform a coherent demodulation. A downlink transmits the reference signal at a predetermined frequency and a predetermined symbol interval in a time-frequency resource. Unlike the downlink, uplink uses a continuous frequency resource to transmit the reference signal at a predetermined OFDM symbol interval. At this point, the reason of using the continuous frequency resource is to use a DFT-spread OFDM (DFTS-OFDM) and is to use a spreading code removing an inter-reference signal interference so that a multiple terminal is used in a multiple cell.

As the number of reference signals is increased in mobile communication, an error rate of data transmission is reduced but transmission capacity is reduced, and therefore the appropriate number of resources of the reference signal needs to be used. The frequency interval of the reference signal is set depending on a coherence bandwidth of a transmission channel and a time interval is set depending on a coherence time of the transmission channel. The coherence time is inversely proportional to a Doppler spread. Therefore, if a speed of the terminal is increased, more reference signals are required for coherent demodulation.

By the way, as the number of reference signals is increased in a radio frame structure, the number of resources allocated to data is reduced as many. Therefore, insertion of non-excessive reference signals may maximize transmission efficiency.

Further, the intervals of the reference signals have a relationship with an estimation range of a frequency offset. As the intervals of the reference signals are close to each other, the estimation range of the frequency offset increases, and therefore it is possible to communicate with a higher speed terminal. Therefore, in a communication system in which a maximum mobile speed of a supportable terminal is determined depending on a structure of an uplink control channel frame, a technical method for supporting a high speed terminal is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for transmitting an uplink control channel having advantages of reducing an error of an uplink control channel signal generated depending on a high Doppler shift situation in high speed mobile environment.

An exemplary embodiment of the present invention provides a method for transmitting an uplink control channel in a mobile communication system, including: generating an uplink control channel signal depending on at least one resource index received from a base station; and transmitting the uplink control channel signal to the base station through a frequency resource block corresponding to the resource index, in which a location where a reference signal included in the uplink control channel signal is allocated is changed depending on the resource index.

A plurality of resource indexes may be allocated to a terminal and a frame structure corresponding to each resource index may be different. The frame structure may represent the number of data symbols and reference signals and a transmission order thereof.

The generating of the uplink control channel signal may include: generating a first uplink control channel signal corresponding to the first resource index, when the resource index includes a first resource index and a second resource index; and generating a second uplink control channel signal corresponding to the second resource index, in which symbol locations of the reference signals included in the first uplink control channel signal and the second uplink control channel signal, respectively, may be different.

The terminal may be classified into a low speed terminal and a high speed terminal and when the terminal is the high speed terminal, a plurality of resource indexes may be configured in the terminal.

The method may further include: receiving and demodulating, by the base station, the uplink control channel signal; performing a correlation between the reference signal included in the uplink control channel signal and a stored reference signal corresponding to the resource index; and estimating a frequency offset on the basis of the correlation result.

Another embodiment of the present invention provides a terminal for transmitting an uplink control channel in a mobile communication system, including: a signal processor generating an uplink control channel signal depending on an applied resource index; a controller transmitting at least one resource index received from a base station to the signal processor; and a radio frequency (RF) unit transmitting an uplink control channel signal provided from the signal processor, in which a location where a reference signal included in the uplink control channel signal is allocated may be changed depending on the resource index.

A plurality of resource indexes may be allocated to the terminal, frame structures corresponding to the respective resource indexes may be different, and the frame structure may represent the number of data symbols and reference signals and a transmission order thereof.

The resource index may include a first resource index and a second resource index, and the signal processor may include: a first physical uplink control channel (PUCCH) generator generating a first uplink control channel signal depending on a first resource index transmitted from the controller; a second PUCCH generator generating a second uplink control channel signal depending on a second resource index transmitted from the controller; an adder adding the first uplink control channel signal and the second uplink control channel signal per subcarrier; and a modulator modulating the signal output from the adder and outputting the modulated signal to the RF unit.

Yet another embodiment of the present invention provides a base station for receiving an uplink control channel in a mobile communication system, including: a radio frequency (RF) unit receiving an uplink control channel signal transmitted from a terminal; a signal processor performing a correlation between a reference signal included in the uplink control channel signal and a stored reference signal corresponding to an applied resource index; a controller providing at least one resource index to the signal processor; and a frequency offset estimator estimating a frequency offset on the basis of a correlation result of the signal processor, in which a location where a reference signal included in the uplink control channel signal is allocated may be changed depending on the resource index.

A plurality of resource indexes may be allocated to the terminal, frame structures corresponding to the respective resource indexes may be different, and the frame structure may represent the number of data symbols and reference signals and a transmission order thereof.

The resource index may include a first resource index and a second resource index The signal processor may include: a demodulator demodulating a signal output from the RF unit to output the corresponding output data to each subcarrier; a first PUCCH demodulator demodulating data corresponding to a first uplink channel signal including the reference signal using the output data of the demodulator and a first resource index transmitted from the controller and acquiring a first cross-correlation value between the reference signal determined by the first resource index and the received reference signal and providing the acquired first cross-correlation value to the frequency offset estimator; and a second PUCCH demodulator demodulating data corresponding to a second uplink channel signal including the reference signal using the output data of the demodulator and a second resource index transmitted from the controller and acquiring a second cross-correlation value between the reference signal determined by the second resource index and the received reference signal and providing the acquired second cross-correlation value to the frequency offset estimator.

The frequency offset estimator may use the first cross-correlation value and the second cross-correlation value to estimate the frequency offset.

The base station may classify the terminal into a low speed terminal and a high speed terminal and configure a plurality of resource indexes for the high speed terminal.

According to an exemplary embodiment of the present invention, it is possible to reduce the intervals of the reference signals of the uplink control channel signals transmitted to the base station by changing a frame structure according to the resource index in the OFDM-based multiple access mobile communication and setting the plurality of resource indexes for the high speed terminal. As a result, it is possible to reduce the error of the uplink control channel by widening the frequency offset estimation range at the time of the uplink control channel demodulation of the base station, for the high Doppler frequency shift generated depending on the high speed movement of the terminal.

### BRIEF DESCRIPTION OF THE DRAWINGS

FIG. 1 is a diagram illustrating an uplink channel of a mobile communication system.

FIG. 2 is a diagram illustrating a structure of a time-frequency resource of an uplink control channel.

FIG. 3 is a diagram illustrating a frame structure of an uplink control channel according to an exemplary embodiment of the present invention.

FIG. 4 is a flow chart of a method for transmitting an uplink control channel according to an exemplary embodiment of the present invention.

FIG. 5 is a configuration diagram of a terminal according to an exemplary embodiment of the present invention.

FIG. 6 is a configuration diagram of a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, “comprising” any components will be understood to imply the inclusion of other elements rather than the exclusion of any other elements.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may also include all or some of the functions of the MT, the MS, the AMS, the HR-MS, the SS, the PSS, the AT, the UE, and the like

Further, the base station (BS) may refer to an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femoto BS), a home node B (HNB), a home eNodeB (HeNB), a pico base station (pico BS), a macro base station (macro BS), a micro base station (micro BS), and the like), and the like and may also include all or some of the functions of the ABS, the node B, the eNodeB, the AP, the RAS, the BTS, the MMR-BS, the RS, the RN, the ARS, the HR-RS, the small base stations, and the like.

An exemplary embodiment of the present invention describes, by way of example, long term evolution (LTE) of 3^{rd} generation partnership project (3GPP) and LTE advanced technologies, but a mobile communication system according to the present invention is not limited thereto.

Hereinafter, a method and an apparatus for transmitting an uplink control channel according to an exemplary embodiment of the present invention will be described with reference to the accompanying drawings.

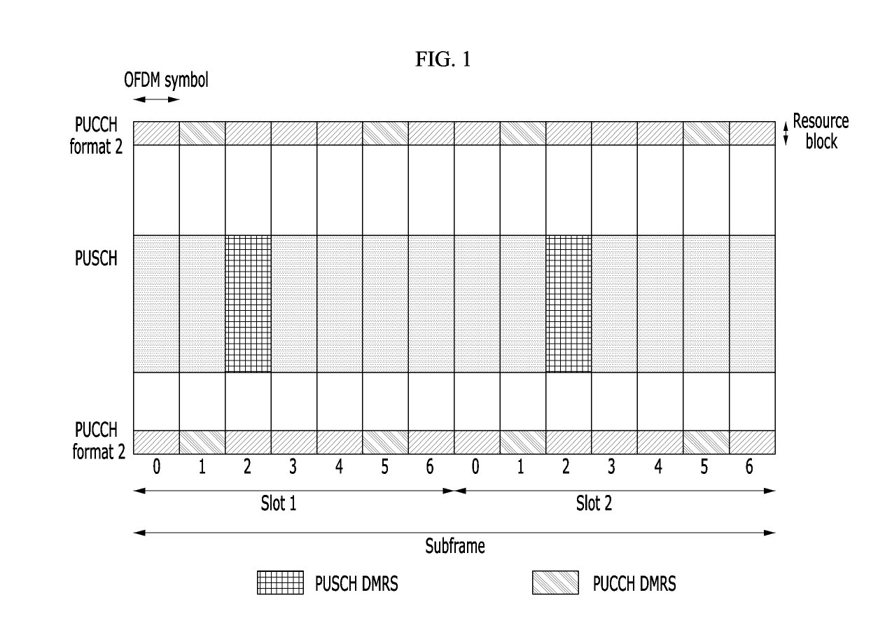

FIG. 1 is a diagram illustrating an uplink channel of a mobile communication system.

In the mobile communication system in which a downlink uses an orthogonal frequency division multiple access (OFDMA) as a terminal multiple access scheme and an uplink uses a single carrier frequency division multiple access (SC-FDMA), an uplink channel may be given as illustrated in FIG. 1.

In the uplink, an uplink data channel (physical uplink shared channel (PUSCH)), an uplink control channel (physical uplink control channel (PUCCH)), a random access channel (physical random access channel (PRACH)), a sounding reference signal (SRS) are transmitted. Uplink data are transmitted through the PUSCH and control information is transmitted through the PUCCH. The PUCCH transmits acknowledgment/negative-ACK (ACK/NACK), a scheduling request, channel state information, or the like. The PUCCH is allocated from frequency resource blocks of both edges of a transmission band and an internal frequency resource block is allocated to the PUSCH. Transmitting/receiving signals through channels such as PUCCH and PUSCH are written in a form of ‘transmitting/receiving channels such as PUCCH and PUSCH’.

As illustrated in FIG. 1, in the PUSCH, a reference signal (for example, demodulation reference signal (DMRS) that is a demodulation reference signal) is transmitted at each slot once and in the PUCCH, the reference signal is transmitted at each slot twice. For example, the PUSCH allocates one reference signal per 0.5 ms (slot), PUCCH format 1 continuously allocates three reference signals per 0.5 ms (slot), and PUCCH format 2 (see FIG. 1) allocates two reference signals per 0.5 ms (slot). Therefore, when a channel coherence time is equal to or larger than 1 ms, the PUSCH may be demodulated by using a reference signal. In the case of the PUCCH format 2, the PUCCH2 may be demodulated even when the coherence time is 0.5 ms. The base station uses the reference signal received through the uplink channel to perform coherent demodulation.

Meanwhile, the uplink control channel is multiple transmitted by allowing a multiple terminal to use the same frequency resource. The PUCCH of the LTE uses a resource block consisting of twelve subcarriers in a frequency allocation unit. Individual resources sharing the same resource blocks are classified by a resource index. For multiplexing, each terminal is allocated an independent sequence having little cross-correlation. To make the independent sequence, in the case of the PUSCH transmission, a Zadoff-Chu (ZC) sequence may be used when the number of resource blocks exceeds three, in the case of the PUSCH transmission, three or less resource blocks may be used, or in the case of the PUCCH transmission, a quadrature phase-shift keying (QPSK)-based sequence may be used.

To additionally make a sequence in addition to the sequence, a phase-rotated reference signal is used. For this purpose, a linear phase rotation in proportion to a subcarrier is applied to a basic sequence. For example, if the linear phase rotation is applied to a code whose length is N_{sc}, a new orthogonal sequence may be generated. When z′ is a basic sequence of an i-th subcarrier, an i-th subcarrier signal y′ of a new sequence is as follows.

yⁱ=e^{j·αi·2π/N}^{_{sc}}·zⁱ (Equation 1)

In the above Equation 1, 0≦α≦N_{sc}−1. In this case, a total N_{sc} of independent sequences may be generated and each sequence may be allocated to different terminals. Applying the linear phase rotation in a frequency domain is the same as applying a cyclic shift (CP) in a time domain. The PUCCH performs hopping on a phase rotation value per OFDM symbol and slot. The phase rotation value is determined depending on the resource index of the uplink control channel that the base station transmits to the terminal. In the LTE-based mobile communication system, the terminal notifies four resource indexes to be used as system information. Further, when the PUCCH transmission is required, the base station transmits resource index information to be selected to the terminal by inserting the resource index information into a downlink control channel (physical downlink control channel (PDCCH)). The terminal demodulates the PDCCH to acquire the corresponding resource index information and transmits an uplink control channel signal through an uplink resource corresponding thereto.

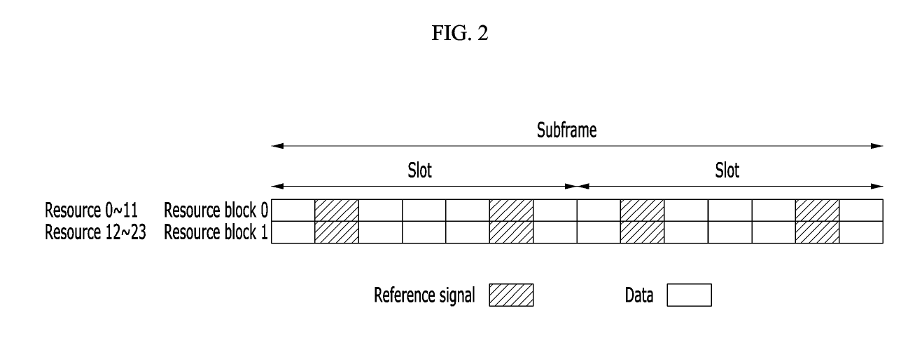

FIG. 2 is a diagram illustrating a structure of a time-frequency resource of an uplink control channel.

The accompanying FIG. 2 illustrates a structure of the resource corresponding to the PUCCH format 2, in which a total four of OFDM symbols by two in a subframe is allocated to each slot as the reference signal

Resource indexes 0-11 of the PUCCH correspond to ones transmitted through resource block 0 and resource indexes 12-23 correspond to ones transmitted through resource block 1. The PUCCHs transmitted through the same resource block have different phase rotation values depending on the resource index.

When m is an OFDM symbol number, symbols mapped to each subcarrier in a frequency resource block are as follows.

When the symbol m is a data symbol,

$${y}_{m} ( n ) = \frac{1}{\sqrt{P}} d ( m ) \cdot {r}_{u , v}^{( a \tilde{p} )} ( n ) , n = 0 , 1 , … , 11 \qquad ( Equation 2 )$$

When the symbol m is a reference signal,

$${y}_{m} ( n ) = \frac{1}{\sqrt{P}} \cdot {r}_{u , v}^{( a \tilde{p} )} ( n ) , n = 0 , 1 , … , 11 \qquad ( Equation 3 )$$

In the above Equations 2 and 3, P represents the number of antennas and r_{u,v}^{(α}^{_{β}}⁾(n) represents a product of a basic sequence r_{u,v}(n) designated as u and v by a phase as much as α_{β}. The u represents a sequence group number used in the PUCCH and v represents a sequence number defined depending on sequence hopping setting. d(m) represents data mapped to (I, Q) signals transmitted at symbol m.

If a temporal symbol interval of the reference signal is determined in the uplink control channel, the frequency offset that may be estimated using the structure is also determined. Therefore, when the terminal that is moving at high speed and then has larger Doppler frequency shift than an estimable frequency offset appears, it is impossible to estimate the frequency offset.

An exemplary embodiment of the present invention provides a method for selectively reducing an interval of a reference signal.

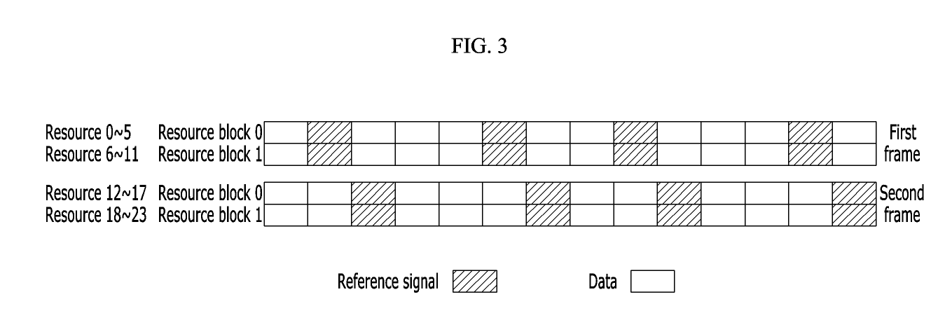

FIG. 3 is a diagram illustrating a frame structure of an uplink control channel according to an exemplary embodiment of the present invention.

According to the exemplary embodiment of the present invention, a location of the reference signal transmitted through the uplink control channel is not fixed and a location where the reference signal is allocated is changed depending on the resource index. As illustrated in the accompanying FIG. 3, when the resource index is given by 0-23, in the case of the resource indexes 0-11, the reference signal is transmitted at, for example, 2, 6, 9, and 13-th OFDM symbols. In the case of the resource indexes 12-23, the reference signal is transmitted at, for example, 3, 7, 10, and 14-th OFDM symbols. The rest symbols other than the symbol at which the reference signal is transmitted are an OFDM symbol for data.

Meanwhile, resource indexes 0-5 correspond to resource block 0 of a first frame and resource indexes 6-11 correspond to resource block 1 of the first frame. Resource indexes 12-17 correspond to resource block 0 of a second frame and resource indexes 18-23 correspond to resource block 1 of the second frame.

As such, due to the characteristics of the uplink control channel that can be multiplexed by a user, a plurality of frame forms may be implemented. Referring to the above Equations 2 and 3, sequences mapped to 12 subcarriers made by the process have a zero correlation value regardless of the d(m). This is because the d(m) does not affect the correlation value even when being multiplied by the QPSK-based spreading code if the d(m) is a binary phase shift keying (BPSK) or quadrature phase shift keying (QPSK) symbol. Therefore, the location of the reference signal may be changed.

According to the related art, the symbol location of the data and the reference signal is fixed, but according to the exemplary embodiment of the present invention, the symbol location may be selected depending on the resource index. Both of the data and the reference signal are generated as the independent sequence, and therefore may be simultaneously used in the same OFDM symbol.

Further, according to the exemplary embodiment of the present invention, if the base station additionally provides the resource index to the terminal, the terminal may transmit slots having different frame structures. An advantage of transmitting the slots having different frame structures is that it can take advantage of advantages generated by using a lot of reference signals such as advantages of reducing an error rate of data transmission.

If the reference signal is transmitted, the base station may estimate the frequency offset using the correlation method. The base station has the phase-rotated reference signals for all the terminals, and therefore calculates the correlation value between the received signal and the phase-rotated reference signal for the corresponding terminal and acquires the correlation value in an OFDM symbol unit including the reference signal. Further, variations of the correlation values are calculated and the respective inter-symbol phase difference is obtained based on the variations. Further, the phase difference may be applied to the following Equation 4 to obtain an estimate of the frequency offset.

$$\hat{ɛ} = \frac{{N}_{FFT} \cdot \hat{θ}}{2 π \cdot L} \qquad ( Equation 4 )$$

In the above Equation 4, N_{FFT} represents the number of points of fast Fourier transform (FFT), \hat{θ} represents the phase difference, and L represents the inter-reference signal time sample interval. By the above Equation 4, it can be appreciated that as the intervals of the reference signals are close to each other, the estimation range of the frequency offset is increased.

According to the exemplary embodiment of the present invention, it is possible to estimate the frequency offset using the resource index mapping as illustrated in the accompanying FIG. 3.

For example, when the resource index 0 is configured in any terminal, the terminal may transmit the reference signal at a predetermined location of the resource block 0 corresponding to the resource index 0 and the base station may use the OFDM symbol of the predetermined location of the resource block 0 to receive the transmitted reference signal and estimate the frequency offset based on the received reference signal. In the resource index 0, as described above, the reference signal is transmitted at 2, 6, 9, and 13-th OFDM symbols, and therefore a minimum interval between the reference signals is 3 OFDM symbols and thus the frequency offset corresponding thereto may be estimated.

By the way, it is assumed that any terminal is allocated the resource index 0 and the resource index 12. In this case, the base station may receive reference signals of 2, 3, 6, 7, 8, 9, 13, and 14-th OFDM symbols that are transmitted through the resource block 0. The minimum interval between the reference signals is 1 OFDM symbol and the frequency offset may be estimated using the reference signal at 1 OFDM symbol interval. Therefore, when a plurality of resource indexes are allocated to the terminal, the estimation range of the frequency offset is increased.

According to the exemplary embodiment of the present invention, the structure of the frame consisting of the reference signal and the data may be selected depending on the resource index allocated to the terminal. In addition, the phase rotation value may also be selected depending on the resource index allocated to the terminal.

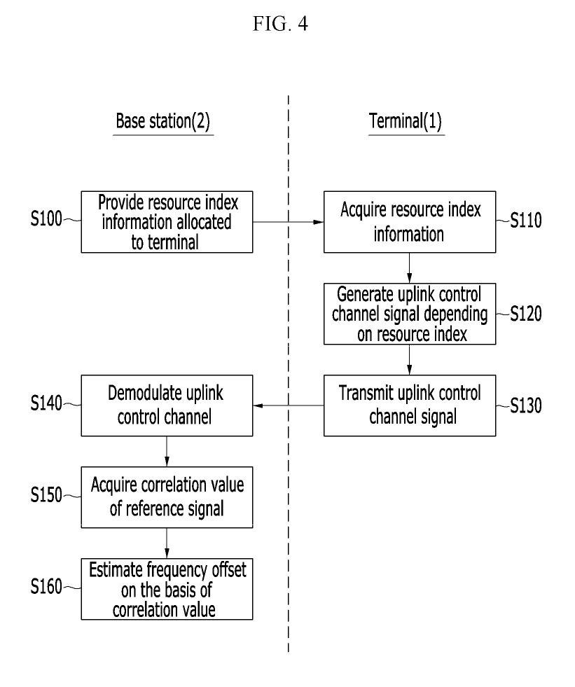

FIG. 4 is a flow chart of a method for transmitting an uplink control channel according to an exemplary embodiment of the present invention. If the base station 2 configures at least one resource index in any terminal 1, the information on the configured resource index is provided to the terminal 1 (S100). The information on the resource index used in one cell is the system information and when each terminal is registered in a cell, may be transmitted to the terminal. Among all the resource indexes in the cell, the resource index used by the terminal 1 may be acquired from the downlink control channel (PDCCH).

Meanwhile, the base station 2 classifies a low speed terminal and a high speed terminal and in the case of the high speed terminal, the number of resource indexes of the uplink control channel may be set to be plural, for example, two and in the case of the low speed terminal, the number of resource indexes of the uplink control channel may be set to be one. When the resource index is set in plural, each resource index may have different frame structures. Here, the frame structure represents the number of data symbols and reference signals in the frame and the transmission order thereof and may have a plurality of structures having different numbers and transmission order depending on the resource index.

The terminal 1 acquires at least one resource index allocated thereto (S110) and generates and transmits the uplink control channel signal (including the reference signal) depending on the acquired resource index (S120 and S130). In detail, the terminal 1 generates the uplink control channel signal using the corresponding frame structure depending on the resource index and transmits the generated uplink control channel signal through the resource block corresponding to the resource index. In this case, when the number of resource indexes is plural, for example, two, a first uplink control channel signal may be generated depending on a first resource index, a second uplink control channel signal is generated depending on a second resource index, and the generated first and second uplink control channel signals may be added and transmitted. The number and locations of transmitted reference signals may be changed and the transmission order of the data symbol and the reference signal may be changed, depending on the frame structure corresponding to the resource index. Among the uplink control channel signals, the reference signals are transmitted by using symbols at a predetermined location of the corresponding resource block, depending on the resource index.

The base station 2 performs the uplink control channel demodulation depending on at least one resource index in the received uplink control channel (S140), calculates the correlation values of the respective reference signals in the demodulation step (S150), and estimates the frequency offset as described above using the correlation values (S160).

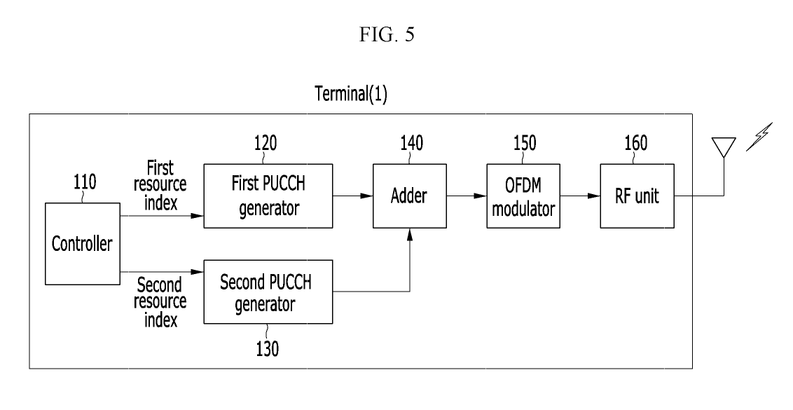

FIG. 5 is a configuration diagram of a terminal according to an exemplary embodiment of the present invention.

As illustrated in FIG. 5, the terminal 1 according to the exemplary embodiment of the present invention includes a controller 110, a first PUCCH generator 120, a second PUCCH generator 130, an adder 140, a modulator 150, and a radio frequency (RF) unit 160. For convenience of description, the first PUCCH generator 120, the second PUCCH generator 130, the adder 140, and the modulator 150 may collectively called a “signal processor”.

When the number of resource indexes set by the base station is plural, for example, two, the controller 110 transmits the corresponding first resource index and second resource index to the first PUCCH generator 120 and the second PUCCH generator 130, respectively.

The first PUCCH generator 120 generates the uplink control channel signal, that is, the first PUCCH signal depending on the first resource index and outputs the generated first PUCCH signal to the adder 140. The second PUCCH generator 130 generates the second PUCCH signal depending on the second resource index and outputs the generated second PUCCH signal to the adder 140.

The adder 140 adds signals of the first PUCCH generator 120 and the second PUCCH generator 130 per subcarrier and outputs the added signal to the modulator 150. The modulator 150 outputs an baseband OFDM signal through inverse FFT (IFFT) and the RF unit 160 converts the baseband OFDM signal into a carrier frequency band and transmits it.

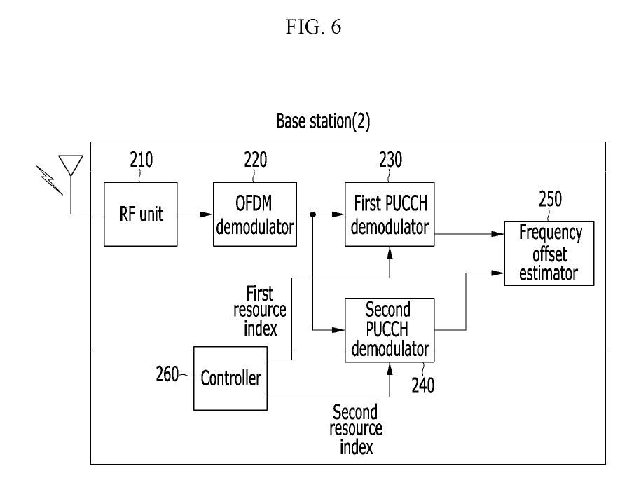

FIG. 6 is a configuration diagram of a base station according to an exemplary embodiment of the present invention.

The base station 2 according to the exemplary embodiment of the present invention includes an RF unit 210, an OFDM demodulator 220, a first PUCCH demodulator 230, a second PUCCH demodulator 240, a frequency offset estimator 250, and a controller 260. For convenience of description, the OFDM demodulator 220, the first PUCCH demodulator 230, and the second PUCCH demodulator 240 may be collectively called “signal processor”.

The RF unit 210 converts a signal input through an antenna into a baseband signal and outputs the baseband signal to the OFDM demodulator 220. The OFDM demodulator 220 uses the FFT to output signals corresponding to the respective subcarriers.

The first PUCCH demodulator 230 uses output data of the OFDM demodulator 220 and the first resource index transmitted from the controller 260 to demodulate the first PUCCH data corresponding to the first PUCCH signal and calculates a cross-correlation value between the reference signal determined by the first resource index and the received reference signal to acquire a first cross-correlation value and outputs the first cross-correlation value to the frequency offset estimator 250.

The second PUCCH demodulator 230 uses output data of the OFDM demodulator 220 and the second resource index transmitted from the controller 260 to demodulate the second PUCCH data corresponding to the second PUCCH signal and calculates a cross-correlation value between the reference signal determined by the second resource index and the received reference signal to acquire a second cross-correlation value and outputs the second cross-correlation value to the frequency offset estimator 250.

The frequency offset estimator 250 uses the first cross-correlation value and the second cross-correlation value to obtain the frequency offset.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting an uplink control channel in a mobile communication system, comprising:
generating an uplink control channel signal depending on at least one resource index received from a base station; and
transmitting the uplink control channel signal to the base station through a frequency resource block corresponding to the resource index,
wherein a location where a reference signal included in the uplink control channel signal is allocated is changed depending on the resource index.

2. The method of claim 1, wherein:
a plurality of resource indexes are allocated to a terminal and a frame structure corresponding to each resource index is different.

3. The method of claim 2, wherein:
the frame structure represents the number of data symbols and reference signals and a transmission order thereof.

4. The method of claim 2, wherein:
the generating of the uplink control channel signal includes:
generating a first uplink control channel signal corresponding to the first resource index, when the resource index includes a first resource index and a second resource index; and
generating a second uplink control channel signal corresponding to the second resource index,
wherein symbol locations of the reference signals included in the first uplink control channel signal and the second uplink control channel signal, respectively, are different.

5. The method of claim 2, wherein:
the terminal is classified into a low speed terminal and a high speed terminal and when the terminal is the high speed terminal, a plurality of resource indexes are configured in the terminal.

6. The method of claim 1, further comprising:
receiving and demodulating, by the base station, the uplink control channel signal;
performing a correlation between the reference signal included in the uplink control channel signal and a stored reference signal corresponding to the resource index; and
estimating a frequency offset on the basis of the correlation result.

7. A terminal for transmitting an uplink control channel in a mobile communication system, comprising:
a signal processor generating an uplink control channel signal depending on an applied resource index;
a controller transmitting at least one resource index received from a base station to the signal processor; and
a radio frequency (RF) unit transmitting an uplink control channel signal provided from the signal processor,
wherein a location where a reference signal included in the uplink control channel signal is allocated is changed depending on the resource index.

8. The terminal of claim 7, wherein:
a plurality of resource indexes are allocated to the terminal, frame structures corresponding to the respective resource indexes are different, and the frame structure represents the number of data symbols and reference signals and a transmission order thereof.

9. The terminal of claim 8, wherein:
the resource index includes a first resource index and a second resource index, and
the signal processor includes:
a first physical uplink control channel (PUCCH) generator generating a first uplink control channel signal depending on a first resource index transmitted from the controller;
a second PUCCH generator generating a second uplink control channel signal depending on a second resource index transmitted from the controller;
an adder adding the first uplink control channel signal and the second uplink control channel signal per subcarrier; and
a modulator modulating the signal output from the adder and outputting the modulated signal to the RF unit.

10. The terminal of claim 9, wherein:
the terminal is a high speed terminal having a mobile speed faster than a set speed.

11. A base station for receiving an uplink control channel in a mobile communication system, comprising:
a radio frequency (RF) unit receiving an uplink control channel signal transmitted from a terminal;
a signal processor performing a correlation between a reference signal included in the uplink control channel signal and a stored reference signal corresponding to an applied resource index;
a controller providing at least one resource index to the signal processor; and
a frequency offset estimator estimating a frequency offset on the basis of a correlation result of the signal processor,
wherein a location where a reference signal included in the uplink control channel signal is allocated is changed depending on the resource index.

12. The base station of claim 11, wherein:
a plurality of resource indexes are allocated to a terminal, frame structures corresponding to the respective resource indexes are different, and the frame structure represents the number of data symbols and reference signals and a transmission order thereof.

13. The base station of claim 12, wherein:
the resource index includes a first resource index and a second resource index, and
the signal processor includes:
a demodulator demodulating a signal output from the RF unit to output the corresponding output data to each subcarrier;
a first PUCCH demodulator demodulating data corresponding to a first uplink channel signal including the reference signal using the output data of the demodulator and a first resource index transmitted from the controller and acquiring a first cross-correlation value between the reference signal determined by the first resource index and the received reference signal and providing the acquired first cross-correlation value to the frequency offset estimator; and
a second PUCCH demodulator demodulating data corresponding to a second uplink channel signal including the reference signal using the output data of the demodulator and a second resource index transmitted from the controller and acquiring a second cross-correlation value between the reference signal determined by the second resource index and the received reference signal and providing the acquired second cross-correlation value to the frequency offset estimator.

14. The base station of claim 13, wherein:
the frequency offset estimator uses the first cross-correlation value and the second cross-correlation value to estimate the frequency offset.

15. The base station of claim 12, wherein:
the base station classifies the terminal into a low speed terminal and a high speed terminal and configures a plurality of resource indexes for the high speed terminal.
